(19) United States
(12) Patent Application Publication
(10) Pub. No.: US 2025/0383698 A1
(43) Pub. Date: Dec. 18, 2025

(54) POWER SAVING ACTIVATION COMMAND

(71) Applicant: MICRON TECHNOLOGY, INC., BOISE, ID (US)

(72) Inventors: Hyun Yoo Lee, Boise, ID (US); John Christopher M. Sancon, Boise, ID (US)

(73) Assignee: MICRON TECHNOLOGY, INC., Boise, ID (US)

(21) Appl. No.: 19/239,740

(22) Filed: Jun. 16, 2025

Related U.S. Application Data
(60) Provisional application No. 63/660,961, filed on Jun. 17, 2024.

(51) Int. Cl. G06F 1/3225; G06F 1/3296

(52) U.S. Cl. CPC G06F 1/3225; G06F 1/3296

(57) ABSTRACT

A memory device can receive multiple commands that cause the memory device to power down. One command is a power down entry command that causes a first set of circuits in the memory device to power down. A power down exit command is received to cause the first set of circuits to exit power down. Another command is an activate with auto-powerdown command that causes a second set of circuits in the memory device to power down. The second set of circuits exit power down based on the detection of a transition in a control signal that is provided to the memory device and based on the detection of a command on a command/address bus that is connected to the memory device.

### CROSS-REFERENCE TO RELATED APPLICATIONS

This application claims the filing benefit of U.S. Provisional Application No. 63/660,961, filed Jun. 17, 2024. This application is incorporated by reference herein in its entirety and for all purposes.

### BACKGROUND

A semiconductor memory device may include a number of memory cells that are used to store data represented by binary digits (or “bits”). The memory cells are typically arranged in an array, and the memory cells are accessed based on row addresses and column addresses. When a group of memory cells will not be accessed, some of the circuitry associated with the group of memory cells may be powered down to reduce the power consumption of the semiconductor memory device. The circuitry is activated when the group of memory cells will be accessed. In some instances, the amount of time the circuitry needs to exit power down and be fully operational can be relatively long, which may adversely impact the performance of the semiconductor memory device.

### BRIEF DESCRIPTION OF THE DRAWINGS

Non-limiting and non-exhaustive examples are described with reference to the following Figures. The elements of the drawings are not necessarily to scale relative to each other. Identical reference numerals have been used, where possible, to designate identical features that are common to the Figures.

FIG. 1 illustrates a block diagram of an example system according to an embodiment of the disclosure;

FIG. 2 illustrates a block diagram of an example semiconductor device according to an embodiment of the disclosure;

FIG. 3 illustrates a block diagram of an example memory module according to an embodiment of the disclosure;

FIG. 4 illustrates a block diagram of example power down circuitry according to an embodiment of the disclosure;

FIG. 5 illustrates a block diagram of example command address circuitry according to an embodiment of the disclosure;

FIG. 6 illustrates an example timing diagram for an activate command, a power down entry command, and a power down exit command according to an embodiment of the disclosure;

FIG. 7 illustrates an example timing diagram for an activate with auto-powerdown command according to an embodiment of the disclosure;

FIG. 8 illustrates a command truth table for an activate command and an activate with auto-powerdown command according to an embodiment of the disclosure; and

FIG. 9 illustrates a flowchart of an example method of operating a memory device according to an embodiment of the disclosure.

### DETAILED DESCRIPTION

In some embodiments, a system can include multiple memory devices or dies. Some or all of the memory devices may be configured on a memory module, and a system may include one or more memory modules. A memory rank refers to the one or more memory devices on a memory module. The memory device(s) in each rank share a distinct chip select signal, but the memory ranks receive the same command, address, data, and control information. During operation of the system, the system can switch between the memory ranks to access different memory devices. When a particular memory rank is to be accessed, that memory rank is selected and activated, and the unselected or inactive memory rank(s) are typically powered down to reduce the overall power consumption of the system. When an inactive memory rank is to be accessed, the currently active memory rank is powered down and the inactive memory rank exits power down. As used herein, “powered down”, “power down”, “powering down”, and “powers down” cover components (e.g., circuits) being turned off completely as well as a reduced operation where the components are not turned off completely but operate at a reduced level or provide a reduced output.

Embodiments described herein provide systems and methods for enabling a memory device to execute multiple commands that cause circuitry within the memory rank to power down. In one embodiment, a power-down entry (PDE) command powers down a first set of circuits in a memory rank (e.g., an inactive memory rank). A power-down exit (PDX) command is provided to the memory rank to cause the first set of circuits to exit power down.

An activate with auto-powerdown (ACTPD) command powers down a second set of circuits in the memory rank. The PDE command and the PDX command do not need to be provided to the memory rank to cause the second set of circuits to enter power down and exit power down, respectively. Instead, in one embodiment, the memory rank automatically enters power down after the ACTPD command is received and exits power down based on a detection in the chip select signal that is provided to the inactive memory rank transitioning to an active signal level (e.g., “0” or low) and a detection of a command on a command and address (CA) bus.

The first set of circuits that are powered down in response to the PDE command include circuits that may take more time to exit power down. The second set of circuits that are powered down in response to the ACTPD command can include circuits that take less time to exit power down (compared to the first set of circuits). Both the PDE command and the ACTPD command result in a reduction of the power consumption of a system, but the PDE command may result in a greater reduction of the power consumption compared to the ACTPD command. Thus, a trade-off may exist between the amount of power savings in a memory device and the amount of time needed to exit power down.

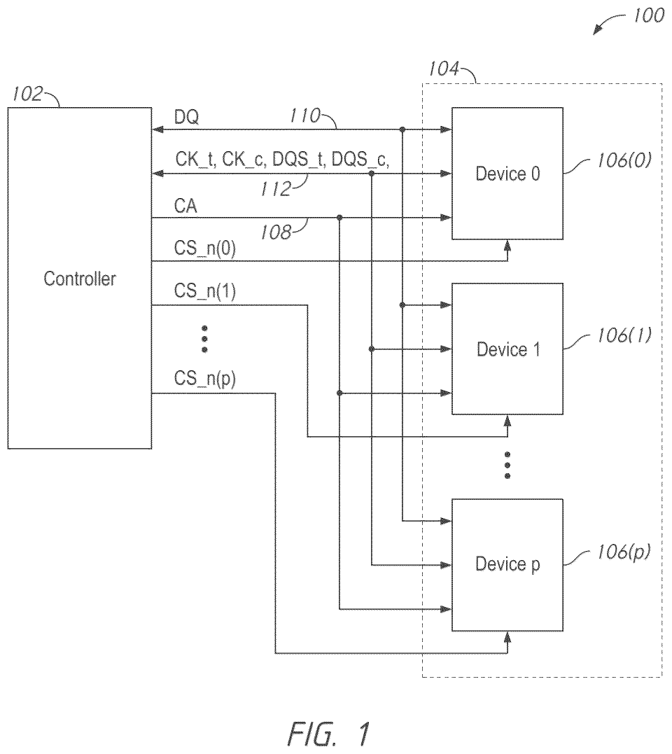

FIG. 1 illustrates a block diagram of an example system 100 according to an embodiment of the disclosure. The system 100 includes a controller 102 and a memory system 104. In the illustrated embodiment, the memory system 104 includes memory devices 106(0)-106(p) (e.g., “Device 0” through “Device p”), where p is a number greater than one (1).

In one embodiment, the memory system 104 is a memory module and the memory devices 106(0)-106(p) are memory ranks. The memory devices 106(0)-106(p) may include a dynamic random-access memory (DRAM), a double data rate (DDR) memory, a low power double data rate (LPDDR) memory, a graphics double data rate (GDDR) memory, or other type of memory. Each memory rank can include one or more memory dies (e.g., DRAM dies).

The memory devices 106(0)-106(p) are each coupled to the command/address, data, and clock busses. The controller 102 and the memory system 104 are in communication over several busses. Commands and addresses (CA) are received by the memory system 104 on a command/address bus 108, and data (DQ) is provided between the controller 100 and the memory system 104 over a data bus 110. Various clocks may be provided between the controller 100 and the memory system 104 over a clock bus 112. The clock bus 112 may include signal lines for providing system clocks CK_t and CK_c received by the memory system 104 and data clocks (strobes) DQS_t and DQS_c received and/or provided by the memory system 104 to the controller 100. Each of the busses may include one or more signal lines on which signals are provided.

The CK_t and CK_c clocks provided by the controller 102 to the memory system 104 are used for timing the provision and receipt of the commands and addresses. The DQS_t and DQS_c clocks are used for timing the provision of data. The CK_t and CK_c clocks are complementary, and the DQS_t and DQS_c clocks are complementary. Clocks are complementary when a rising edge of a first clock occurs at a same time as a falling edge of a second clock, and when a rising edge of the second clock occurs at a same time as a falling edge of the first clock.

The controller 102 provides commands to the memory system 104 to perform memory operations. Examples of memory commands include timing commands for controlling the timing of various operations, access commands for accessing the memory, such as read commands for performing read operations and write commands for performing write operations, as well as other commands and operations. The command signals provided by the controller 102 to the memory system 104 further include external control signals (e.g., CS_n(0), CS_n(1), CS_n(p)). Commands, addresses, data, and clocks are provided to all of the memory devices 106(0)-106(p), and the external control signals provided on respective select signal lines are used to select which of the memory devices 106(0)-106(p) will respond to the commands and perform the corresponding operations. In some embodiments, a respective control signal is provided to each memory device 106(0)-106(p) of the memory system 104. The controller 102 provides an active control signal (e.g., a low or “0”) to select the corresponding memory device 106(0)-106(p). While the respective control signal is active, the corresponding memory device 106(0)-106(p) is selected to receive the commands and addresses provided on the command/address bus 108. In some embodiments, the external control signal is used in combination with the CA signals to indicate different memory commands and memory operations.

In operation, when a read command and an associated address are provided by the controller 102 to the memory system 104, the memory device 106(0)-106(p) selected by the external control signals receives the read command and the associated address, and performs a read operation to provide the controller 102 with read data from a memory location corresponding to the associated address. The read data is provided by the selected memory device 106(0)-106(p) to the controller 102 according to a timing relative to receipt of the read command. For example, the timing may be based on a read latency (RL) value that indicates the number of clock cycles of the CK_t and CK_c clocks (a clock cycle of the CK_t and CK_c clocks is referenced as tCK) after the read command when the read data is provided by the selected memory device 106(0)-106(p) to the controller 102. The RL value is programmed by the controller 102 in the memory devices 106(0)-106(p). For example, the RL value may be programmed in respective mode registers of the memory devices 106(0)-106(p). As known, mode registers included in each of the memory devices 106(0)-106(p) may be programmed with information for setting various operating modes and/or to select features for operation of the memory devices 106(0)-106(p). One of the settings may be for the RL value.

In preparation of the selected memory device 106(0)-106(p) providing the read data to the controller 102, the memory device provides active data clocks DQS_t and DQS_c. A clock is active when the clock transitions between low and high clock levels periodically. Conversely, a clock is inactive when the clock maintains a constant clock level and does not transition periodically. The DQS_t and DQS_c clocks are provided by the memory device 106(0)-106(p) performing the read operation to the controller 102 for timing the provision of read data to the controller 102. The controller 102 may use the DQS_t and DQS_c clocks for receiving the read data.

In operation, when a write command and an associated address are provided by the controller 102 to the memory system 104, the memory device 106(0)-106(p) selected by the external control signals receives the write command and the associated address, and performs a write operation to write data from the controller 102 to a memory location corresponding to the associated address. The write data is provided to the selected memory device 106(0)-106(p) by the controller 102 according to a timing relative to receipt of the write command. For example, the timing may be based on a write latency (WL) value that indicates the number of clock cycles of the CK_t and CK_c clocks after the write command when the write data is provided to the selected memory device 106(0)-106(p) by the controller 102. The WL value is programmed by the controller 102 in the memory devices 106(0)-106(p). For example, the WL value may be programmed in respective mode registers of the memory devices 106(0)-106(p).

In preparation of the selected memory device 106(0)-106(p) receiving the write data from the controller 102, the controller 102 provides active data clocks DQS_t and DQS_c to the memory system 104. The DQS_t and DQS_c clocks may be used by the selected memory device 106(0)-106(p) to generate internal clocks for timing the operation of circuits to receive the write data. The data is provided by the controller 102 and the selected memory device 106(0)-106(p) receives the write data according to the DQS_t and DQS_c clocks, which is written to a memory location corresponding to the memory address.

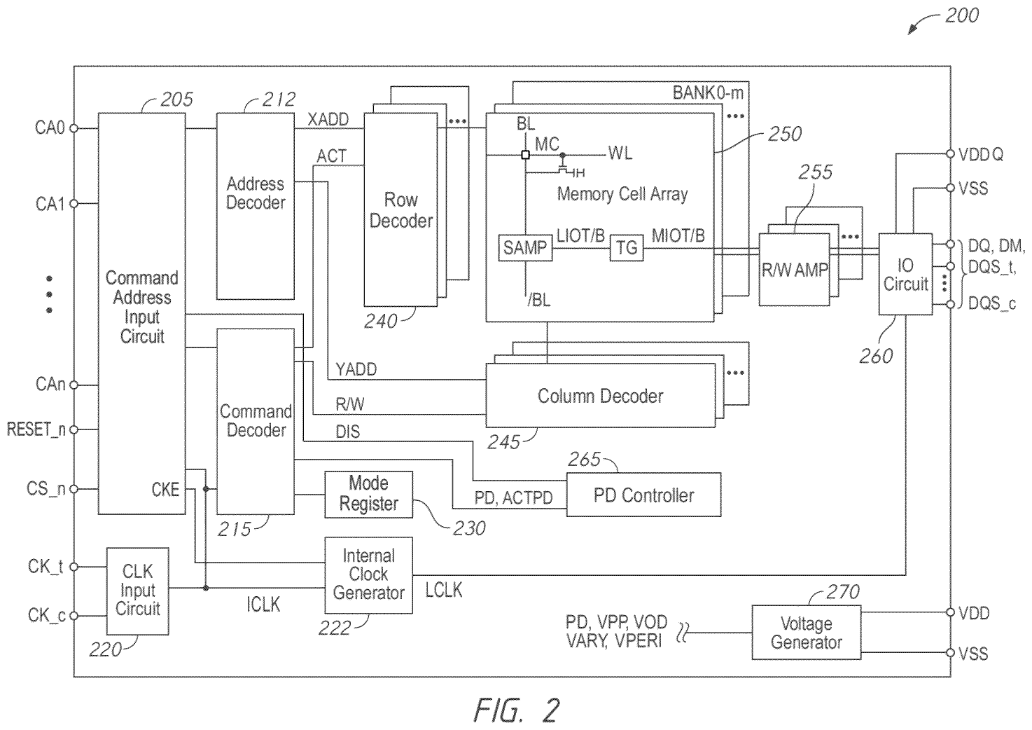

FIG. 2 illustrates a block diagram of a semiconductor device according to an embodiment of the disclosure. The semiconductor device 200 may include, without limitation, a memory such as a DRAM. In one embodiment, one or more semiconductor devices 200 are included in a memory rank.

The semiconductor device 200 includes a memory array 250. The memory array 250 is shown as including a plurality of memory banks. In the embodiment of FIG. 2, the memory array 250 is shown as including memory banks BANK0-BANKm. Each memory bank includes a plurality of word lines WL, a plurality of bit lines BL and/BL, and a plurality of memory cells MC arranged at intersections of the plurality of word lines WL and the plurality of bit lines BL and/BL. Selection of the word line WL is performed by a row decoder 240 and selection of the bit lines BL and/BL is performed by a column decoder 245. In the embodiment of FIG. 2, the row decoder 240 includes a respective row decoder for each memory bank and the column decoder 245 includes a respective column decoder for each memory bank. The bit lines BL and/BL are coupled to a respective sense amplifier (SAMP). Read data from the bit line BL or/BL is amplified by the sense amplifier SAMP and transferred to read/write amplifiers 255 over complementary local data lines (LIOT/B), transfer gate (TG), and complementary main data lines (MIOT/B). Conversely, write data output from the read/write amplifiers 255 is transferred to the sense amplifier SAMP over the complementary main data lines MIOT/B, the transfer gate TG, and the complementary local data lines LIOT/B, and written in the memory cell MC coupled to the bit line BL or/BL.

A mode register 230 stores information, for example, configuration and status information for the semiconductor device 200. The mode register 230 may be accessed through mode register read commands and mode register write commands. The mode register access commands cause the semiconductor device 200 to perform mode register read operations and mode register write operations. A mode register read command causes the semiconductor device 200 to provide information stored by the mode register 230 that is accessed, and a mode register write command causes the semiconductor device 200 to store information in the mode register 230 that is accessed. The mode register 230 may include several mode registers, with each of the mode registers corresponding to a mode register address and storing different types of information.

The semiconductor device 200 may employs a plurality of external terminals that include command and address (CA) and control terminals (Reset_n and CS_n) coupled to a command and address (CA) bus to receive commands and addresses, an external reset_n signal and an external control CS_n signal. The external terminals may further include clock terminals to receive clocks CK_t and CK_c, and data clocks DQS_t and DQS_c, data terminals DQ and DM, and power supply terminals to receive power supply potentials VDD, VSS, and VDDQ.

The clock terminals are supplied with external clocks CK_t and CK_c that are provided to a CLK input buffer 220. The external clocks may be complementary. The CLK input buffer 220 generates an internal clock ICLK based on the CK_t and CK_c clocks. The ICLK clock is provided to a command decoder 215, a command/address input circuit 205, and to an internal clock generator 222. The internal clock generator 222 provides various internal clocks LCLK based on the ICLK clock. The LCLK clocks may be used for timing operation of various internal circuits.

The CA terminals (e.g., CA0-CAn) may be supplied with commands and memory addresses. The memory addresses supplied to the CA terminals are transferred, via the command/address input circuit 205, to an address decoder 212. The address decoder 212 receives the address and supplies a decoded row address XADD to the row decoder 240 and supplies a decoded column address YADD to the column decoder 245. The CA terminals may be supplied with commands. Examples of commands include access commands for accessing the memory, such as read commands for performing read operations and write commands for performing write operations, mode register write and read commands for performing mode register write and read operations, PDE commands for performing power down operations, activate (ACT) commands for performing activation operations, PDX commands for performing power down exit operations, ACTPD commands for performing activate and auto-power down operations, as well as other commands and operations.

The commands may be provided as internal command signals to the command decoder 215 via the command/address input circuit 205. The command decoder 215 includes circuits to decode the internal command signals to generate various internal signals and commands for performing operations. For example, the command decoder 215 may provide a row command signal ACT to select a word line, a column command signal R/W to select a bit line, a PD signal to cause a first set of circuits to power down, and an ACTPD signal to cause a second set of circuits to power down.

A power down (PD) controller 265 controls the power down operations based on receiving the PD signal and the ACTPD signal from the command decoder 215. As will be described in more detail later, the PD signal may cause a first set of circuits in the semiconductor device 200 to power down. The ACTPD signal can cause a second set of circuits in the semiconductor device 200 to power down.

The power supply terminals are supplied with power supply potentials VDD and VSS. The power supply potentials VDD and VSS are supplied to an internal voltage generator circuit 270. The internal voltage generator circuit 270 generates various internal potentials, such as VPP, VOD, VARY, VPERI, and the like, based on the power supply potentials VDD and VSS supplied to the power supply terminals. The internal potential VPP is mainly used in the row decoder 240, the internal potentials VOD and VARY are mainly used in the sense amplifiers SAMP included in the memory array 250, and the internal potential VPERI is used in many peripheral circuit blocks. The internal voltage generator circuit 270 also receives the PD signal.

The power supply terminals are also supplied with power supply potentials VDDQ and VSS. The power supply potentials VDDQ and VSS are supplied to the input/output circuit 260. The power supply potentials VDDQ and VSS supplied to the power supply terminals may be the same potentials as the power supply potentials VDD and VSS supplied to the power supply terminals in an embodiment of the disclosure. The power supply potentials VDDQ and VSS supplied to the power supply terminals may be different potentials from the power supply potentials VDD and VSS supplied to the power supply terminals in another embodiment of the disclosure. The power supply potentials VDDQ and VSS supplied to the power supply terminals are used for the input/output circuit 260 so that power supply noise generated by the input/output circuit 260 does not propagate to the other circuit blocks.

When a read command, a row address and a column address are timely supplied, read data is read from memory cells in the memory array 250 corresponding to the row address and the column address. The read command is received by the command decoder 215, which provides internal commands so that read data from the memory array 250 is provided to the read/write amplifiers 255. The read data is output to outside from the data terminals DQ via the input/output circuit 260. The DQS_t and DQS_c clocks are provided externally from clock terminals for timing the provision of the read data by the input/output circuit 260. The external terminals DQ include several separate terminals, each providing a bit of data synchronized with a clock edge of the DQS_t and DQS_c clocks.

When the write command, a row address and a column address are timely supplied, write data supplied to the data terminals DQ is written to a memory cells in the memory array 250 corresponding to the row address and the column address. A data mask may be provided to the data terminals DM to mask portions of the data when written to memory. The write command is received by the command decoder 215, which provides internal commands so that the write data is received by input receivers in the input/output circuit 260. DQS_t and DQS_c clocks are also provided to the external clock terminals (e.g., by a controller) for timing the receipt of the write data by the input receivers of the input/output circuit 260. The write data is supplied via the input/output circuit 260 to the read/write amplifiers 255, and by the read/write amplifiers 255 to the memory array 250 to be written into the memory cell MC. As previously described, the external terminals DQ include several separate terminals. With reference to a write operation, each external terminal DQ concurrently receives a bit of data synchronized with a clock edge of the DQS_t and DQS_c clocks.

When a PDE command is received, and the chip select signal CS_n is at an active signal level (e.g., a low or “0”), a first set of circuits are powered down to reduce power consumption. The PDE command is received by the command decoder 215, which provides internal commands to cause the first set of circuits to power down.

When a PDX command is received, and the chip select signal CS_n is at an active signal level (e.g., a low or “0”), the first set of circuits exit power down. The PDX command is received by the command decoder 215, which provides internal commands to cause the first set of circuits that are associated with the formerly inactive memory rank to exit power down. As will be described in more detail later, the first set of circuits include circuits that use a first time period (tXP) to exit power down.

When an ACTPD command is received, and the chip select signal CS_n is at an active signal level (e.g., a low or “0”), a second set of circuits are powered down to reduce power consumption. The ACTPD command is received by the command decoder 215, which provides internal commands to cause the second set of circuits to power down. As will be described in more detail later, the second set of circuits include circuits that use a second time period (tXP(Fast)) to exit power down, where tXP(Fast) is less than tXP.

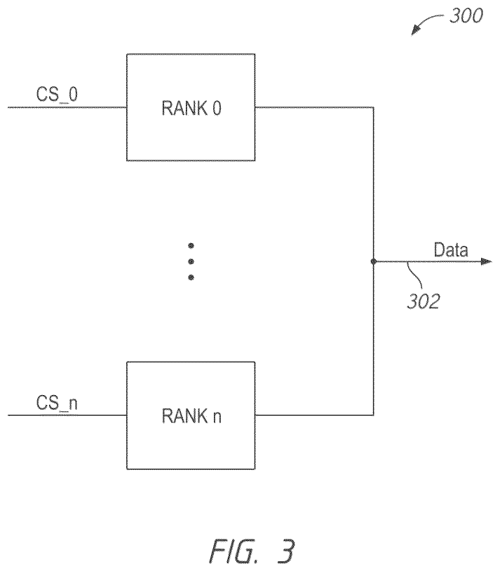

FIG. 3 illustrates a block diagram of an example memory module 300 according to an embodiment of the disclosure. A memory module can include one or more memory ranks. In the illustrated embodiment, the memory module 300 includes “n” memory ranks, where n is a number greater than one. Each memory rank may include one or more memory devices. Each memory rank is connected to a distinct chip select (CS_n) signal line and the output of each memory rank is connected to a data bus 302. For example, the memory devices of a memory rank may be connected to a command CS_n signal line and to the data bus 302. Which memory rank is able to transmit or receive data on the data bus 302 is controlled by a respective chip select signal. For example, when the memory rank 0 is to receive or output data, the chip select signal (CS_0) provided to the memory rank 0 transitions to an active signal level (e.g., a low or “0” state) and the remaining chip select signals are set to an inactive signal level (e.g., a high or “1” state). When data is to be input or output from another memory rank, the chip select signal provided to that memory rank transitions to an active signal level (e.g., a low or “0” state) and the chip select signal provided to the memory rank 0 (as well as any other chip select signals) is set to an inactive signal level (e.g., a high or “1” state). In this manner, a memory device or a controller (e.g., controller 102 of FIG. 1) can control which memory rank is transmitting or receiving data on the data bus 302.

During the operation of a memory module (e.g., a memory module with two or more ranks), circuitry associated with the memory rank(s) that are not accessed may be powered down to reduce the power consumption of a system. In one embodiment, a PDE command is transmitted from a controller (e.g., the controller 102 of FIG. 1) to power down a first set of circuits associated with a non-accessed or inactive memory rank. When an inactive memory rank is going to be accessed, the controller may transmit an ACT command and a PDX command that cause the inactive memory rank to become active and causes the first set of circuits associated with that memory rank to exit power down. In some instances, the amount of time needed by the first set of circuits to exit power down can be relatively long. This longer power down exit time may create a performance penalty in the memory device.

Embodiments described herein provide systems and methods to execute multiple commands that cause circuitry in a memory rank to power down. The multiple commands include the PDE command and the ACTPD command. In one embodiment, the ACTPD command is transmitted from a controller (e.g., the controller 102 of FIG. 1) to power down a second set of circuits associated with a non-accessed or inactive memory rank. When an inactive memory rank is going to be accessed, a transition in the CS_n signal provided to the inactive memory rank is detected and a command on the CA bus is detected. In one embodiment, the CS_n signal may transition from an inactive signal level (e.g., “1” or high) to an active signal level (e.g., “0” or low). This combination causes the second set of circuits to automatically exit power down. In some instances, the amount of time needed by the second set of circuits to exit power down is less than the amount of time needed by the first set of circuits to exit power down.

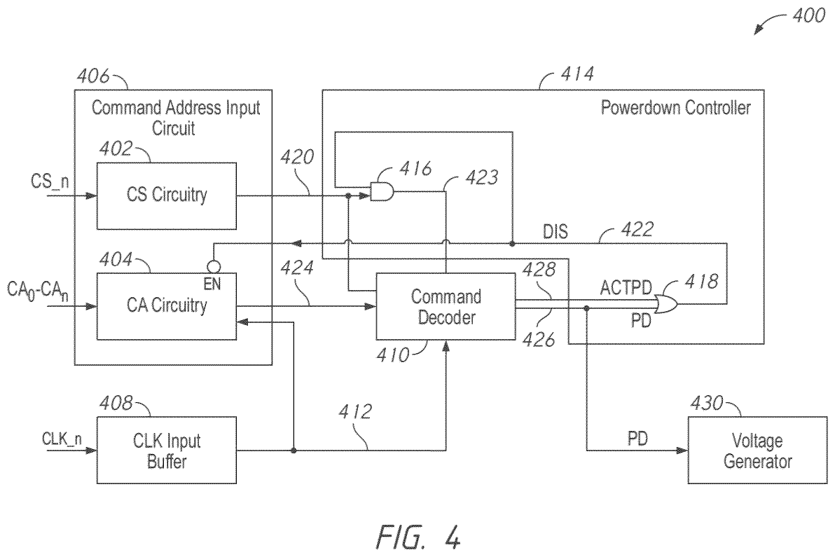

FIG. 4 illustrates a block diagram of example power down circuitry 400 according to an embodiment of the disclosure. The power down circuitry 400 provides the PD signal that causes the first set of circuits to power down or to reduce the operation of the circuits, or the ACTPD signal that causes the second set of circuits to power down. In one embodiment, the first set of circuits includes CA input buffers in a command/address input circuit and a voltage generator circuit (e.g., the command/address input circuit 205 and the internal voltage generator circuit 270 of FIG. 2). The second set of circuits may include one or more circuits in the command/address input circuit. In one embodiment, the CA input buffers may be powered down completely (e.g., turned off completely) and the voltage generator can be powered down such that the output (e.g., voltage level) of the voltage generator circuit is reduced. For example, an internal regulated voltage and/or the voltage level provided to a WL can be lowered to reduce leakage current. In some implementations, the voltage level may be reduced by approximately two hundred (200) mV. Greater or lesser amounts of voltage level reductions can be implemented in other embodiments.

The power down circuitry 400 includes CS circuitry 402 and CA circuitry 404 that may be included in a command/address input circuit 406. The CS circuitry 402 receives the CS_n signal, and the CA circuitry 404 receives the CA signals (e.g., the CA0-CAn signals). The command/address input circuit 406 can be implemented as the command/address input circuit 205 shown in FIG. 2.

A clock (CLK) input buffer 408 receives one or more clock signals (e.g., CK_t and CK_c signals). The CLK input buffer 408 may provide an internal clock signal to the command/address input circuit 406 and a command decoder circuit 410 (via signal line 412). The CLK input buffer circuit 410 can be implemented as the CLK input buffer circuit 220 shown in FIG. 2, and the command decoder circuit 410 may be implemented as the command decoder circuit 215 of FIG. 2.

The power down circuitry 400 further includes a power down controller circuit 414. The example power down controller circuit 412 includes a first logic circuit 416 and a second logic circuit 418. In the illustrated embodiment, the first logic circuit 416 is an AND circuit and the second logic circuit 418 is an OR circuit. The power down control circuit 414 may be implemented as the PD controller 265 shown in FIG. 2.

An output of the CS circuitry 402 is input into the command decoder circuit 410 and a first input of the first logic circuit 416 (via signal line 420). An output of the second logic circuit 418 is input into a second input of the first logic circuit 416 (via signal line 422). An output of the CA circuitry 404 is input into the command decoder circuit 410 on signal line 424. The PD signal is input into a first input of the second logic circuit 418. The ACTPD signal is input into a second input of the second logic circuit 418. The PD signal is also input into a voltage generator circuit 430. In some embodiments, the voltage generator circuit 430 may be implemented as the internal voltage generator circuit 270 shown in FIG. 2.

The command decoder circuit 410 outputs the PD signal on signal line 426 and the ACTPD signal on signal line 428. When the PDE command is received, the command decoder circuit 410 sets the PD signal to a first signal level (e.g., “1” or high) and the ACTPD signal to a second signal level (e.g., “0” or low). In this manner, a disable (DIS) signal on signal line 422 is set to the first signal level (e.g., “1” or high). The DIS signal is input into an enable (EN) input of the CA circuitry 404, which causes some or all of the CA circuitry 404 to power down (e.g., turn off completely). In one embodiment, CA input buffers in the CA circuitry 404 are powered down. The PD signal is also received by the voltage generator circuit 430, which causes the voltage generator 430 to power down (e.g., reduce output voltage level).

The CS_n signal is at a first signal level (e.g., a “1” or high) when the memory rank associated with the CS_n signal is inactive. When the memory rank is to exit power down, a PDX command is received and command decoder circuit 410 responsively sets the PD signal to a second signal level (e.g., a “0” or low) to cause the DIS signal to transition to a second signal level (e.g., “0” or low). When the PD signal and the DIS signal are at the second signal level, the CA circuitry 404 and the voltage generator circuit 430 exit power down.

When the ACTPD command is received, the command decoder circuit 410 sets the ACTPD signal to a first signal level (e.g., “1” or high) and the PD signal to a second signal level (e.g., “0” or low). Based on these signal levels, the DIS signal on signal line 422 is set to the first signal level (e.g., “1” or high). The DIS signal is input into the EN input of the CA circuitry 404, which causes some or all of the CA circuitry 404 to power down. Because the PD signal is at the second signal level (e.g., “0” or low), the voltage generator circuit 430 is not powered down (e.g., the output of the voltage generator circuit is not reduced).

The CS_n signal is at the first signal level (e.g., a “1” or high) when the memory rank associated with the CS_n signal is inactive. When the memory rank is to exit power down, the CS_n signal transitions from the first signal level to the second signal level (e.g., “0” or low). Based on the transition in the CS_n signal and on a command on the CA bus (e.g., CA0-CAn at the CA circuitry 404), the command decoder circuit 410 sets the ACTPD signal a second signal level (e.g., “0” or low), which in turn sets the DIS signal to the second signal level and causes the CA circuitry 404 to exit power down.

Thus, in some embodiments, the first set of circuits enter power down in response to the receipt of a PDE command and exit power down in response to the receipt of a PDX command. The second set of circuits enter power down in response to the receipt of the ACTPD command and exit power down in response to a transition in the CS_n signal in combination with a command on the CA bus. In one embodiment, the CS-N signal transitions to an active signal level. The command can be any command, such as a read command or a write command. Additionally, the command can be a command that is to be executed by an active memory rank that shares the CA bus with the inactive memory rank.

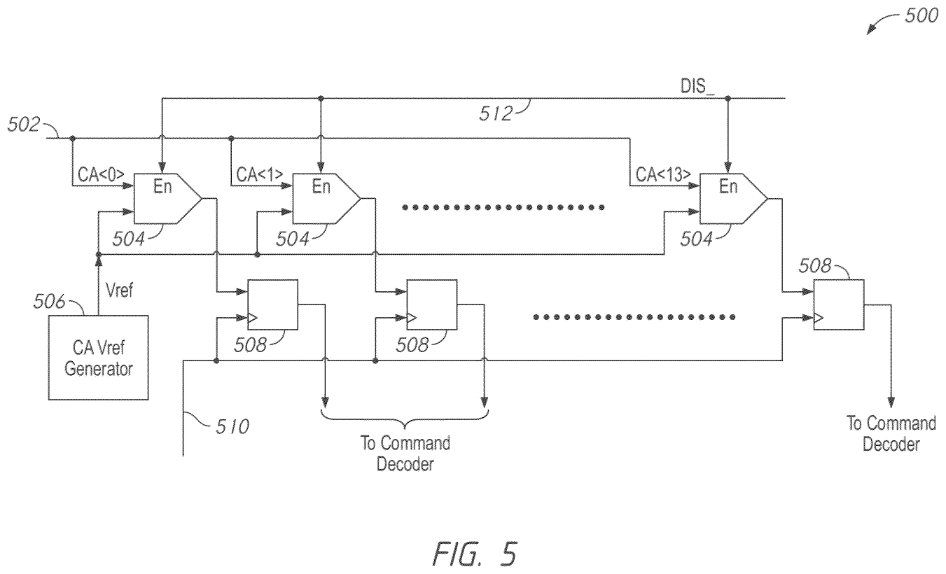

FIG. 5 illustrates a block diagram of example command address circuitry 500 according to an embodiment of the disclosure. Some or all of the CA circuitry 500 is included in the first set of circuits that is powered down based on the assertion of the PD signal (in addition to powering down (e.g., lowering the output of) the voltage generator circuit 430 of FIG. 4). Additionally, some or all of the CA circuitry 500 is included in the second set of circuits that is powered down based on the assertion of the ACTPD signal. The CA circuitry 500 may be implemented as the CA circuitry 404 of FIG. 4.

As CA signals are received by a memory device (e.g., semiconductor device 200 of FIG. 2) on signal line 502, the CA signals may be provided to a buffer stage including CA input buffers 504 prior to being decoded by a command decoder (e.g., command decoder 215 of FIG. 2). The CA input buffers 504 may compare the CA signals to a reference voltage (Vref) output by a CA voltage reference generator 506. The CA voltage reference generator 506 may be within an element of the memory device or included in a separate power supply. The Vref signal and the CA signals are compared to determine the signal level (e.g., a “high” or “low” state) of each CA signal. Once the signal level of a CA signal is known, the CA signal may be sent from each CA input buffer 504 to a respective latch 508. Each latch 508 receives a clock signal CLK on signal line 510 (e.g., ICLK signal of FIG. 2), and based on the clock signal, the latches 508 may control the timing of transmitting the CA signals to the command decoder.

In the illustrated embodiment, the disable_bar (DIS_) signal provided on signal line 512 is received by each of the CA input buffers 504 at an enable input (EN). The DIS_ signal is complementary to the DIS signal shown in FIG. 4. When the DIS signal is high (e.g., “1”), the DIS_ signal is low (e.g., “0”), and vice versa. The DIS_ signal is set to a first signal level to activate the CA input buffers 504, and to a second signal level (e.g., “0” or low) to power down the CA input buffers 504.

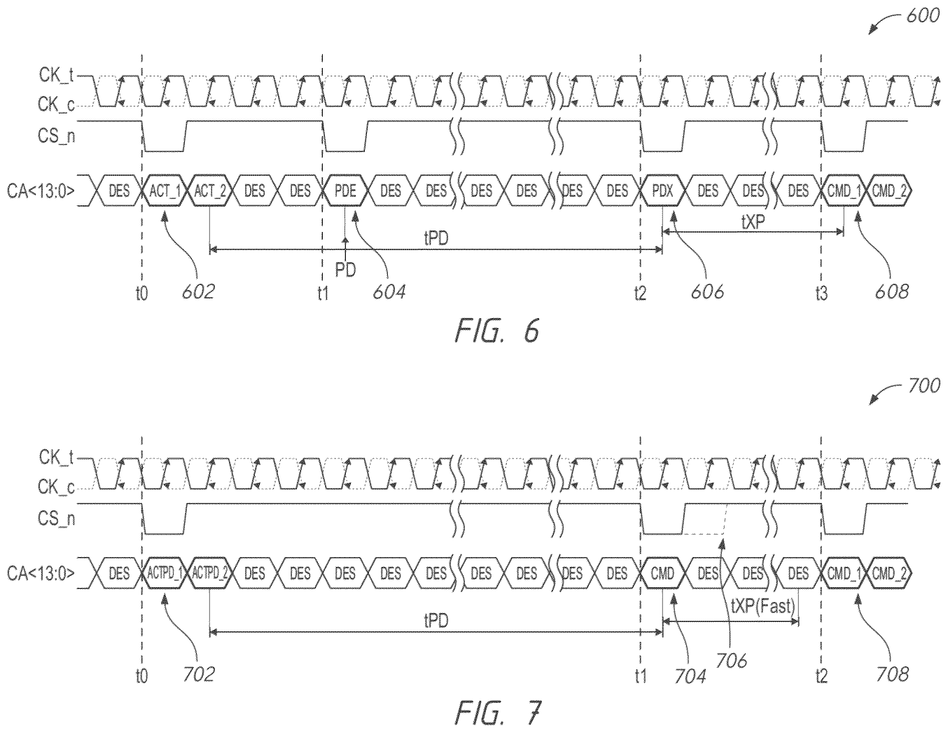

FIG. 6 illustrates an example timing diagram 600 for an activate command, a power down entry command, and a power down exit command according to an embodiment of the disclosure. At time to, the CS signal for a memory rank transitions to an active signal level (e.g., “0” or low) and an ACT command 602 is received on the CA bus. In some embodiments, the ACT command 602 is a two clock-cycle command, where ACT_1 is received on the first clock cycle and ACT_2 is received on the second clock cycle. The ACT command 602 activates a WL in the memory rank (e.g., in a memory bank Bank0-m in FIG. 2). Additionally, in some implementations, the specification for a memory device requires the CS signal to transition to a high signal level (e.g., “1”) for the second clock cycle (e.g., when ACT_2 is received). One example of such a memory device is a Double Data Rate 5 Synchronous Dynamic Random-Access Memory (DDR5 DRAM).

At time t1, the CS signal transitions to the active signal level and a PDE command 604 is received on the CA bus. The PDE command 604 causes the memory rank to power down and become inactive. With the PDE command 604, the first set of circuits power down (e.g., the CA circuitry 404 and the voltage generator circuit 430 in FIG. 4). At time t2, the CS signal transitions to the active signal level and a PDX command 606 is received on the CA bus. In one embodiment, the PDX command 606 is a no operation (no-op) command that causes the inactive memory rank (e.g., the first set of circuits) to exit power down. At time t3, the CS signal transitions to the active signal level and a command 608 is received for the now active memory rank on the CA bus. The command 608 can be any command, such as another ACT command, a read command, or a write command.

FIG. 7 illustrates an example timing diagram 700 for an activate with auto-powerdown command according to an embodiment of the disclosure. At time to, the CS signal transitions to an active signal level (e.g., “0” or low) and an ACTPD command 702 is received on the CA bus. In some embodiments, the ACTPD command 702 is a two clock-cycle command, where ACTPD_1 is received on the first clock cycle and ACTPD_2 is received on the second clock cycle. The ACTPD command 702 activates a WL in a memory rank and will cause the memory rank to automatically power down after one or more clock cycles pass after the ACTPD command 702 is received. With the ACTPD command 702, the second set of circuits are powered down (e.g., some of the CA circuitry 404 in FIG. 4). Like the timing diagram in FIG. 6, in some implementations the CS signal transitions to an inactive signal level (e.g., “1” or high) for the second clock cycle (e.g., when ACTPD_2 is received).

At time t1, the CS signal transitions to the active signal level and a command 704 is received on the CA bus. The command 704 can be any one or two clock-cycle command and does not have to be a no-op command. Example commands include, but are not limited to, another ACT command, a read command, or a write command. The command may be intended for (e.g., to be executed by) an active memory rank that shares the CA bus with the currently inactive rank. Based on the combination of the CS signal transitioning to the active signal level and the command on the CA bus, the inactive memory rank automatically exits power down (e.g., the second set of circuits exit power down).

Since both the active memory rank and the inactive memory rank receive the command 704 on the CA bus, the CS signal provided to the inactive rank may remain at the low signal level for the second clock cycle (see 706). In some embodiments, the command 704 is aborted at the inactive memory rank based on the CS signal that is provided to the inactive memory rank being set to the low signal level for two consecutive clock cycles when the command 704 is received.

At time t2, the CS signal transitions to the active signal level and a command 708 for the now active memory rank is received on the CA bus. The command 708 can be any command, such as an ACT command, a read command, or a write command.

In FIG. 6, the total amount of time the inactive memory rank is powered down is represented by the time period tPD, and the total amount of time the memory rank uses to exit power down is represented by the time period tPX. In FIG. 7, the total amount of time the inactive memory rank is powered down is represented by the time period tPD, and the total amount of time the memory rank uses to exit power down is represented by the time period tPX(Fast). The time period tPX(Fast) is shorter than the time period tPX. Thus, the memory rank exits power down more quickly with the ACTPD command compared to the PDX command. The shorter time period tPX(Fast) can result in an improvement in the function of a memory device. Additionally, or alternatively, the absence of the PDE command and the PDX command may improve the efficiency of the CA bus.

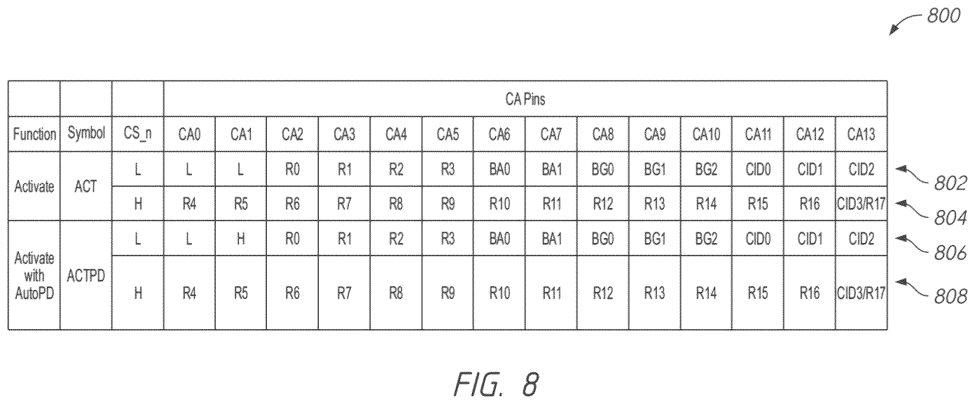

FIG. 8 illustrates a command truth table 800 for an activate (ACT) command and an activate with auto-powerdown (ACTPD) command according to an embodiment of the disclosure. The ACT command and the ACTPD command each includes a series of bits for the CS_n signal and the CA signal. The ACT command and the ACTPD command are two clock-cycle commands in the illustrated embodiment, so the command truth table 800 presents a first row 802 for the first clock cycle of the ACT command, a second row 804 for the second clock cycle of the ACT command, a third row 806 for the first clock cycle of the ACTPD command, and a fourth row 808 for the second clock cycle of the ACTPD command.

One or more bits in the ACT command may be used to indicate a command is the ACT command, and one or more bits in the ACT command can be used to indicate a command is the ACTPD command. In the illustrated embodiment, the CA0 bit and the CA1 bit in the first clock cycle of the ACT command are at a low state (e.g., “0”). Comparing the CA0 bit and the CA1 bit in the ACT command with the CA0 bit and the CA1 bit in the ACTPD command, the CA0 bit is at a low state and the CA1 bit is at a high state (e.g., “1”) in the first clock cycle of the ACTPD command. Thus, the state of the CA1 bit can be used to define a command as the ACT command or the ACTPD command. In other embodiments, any number of bits (e.g., one) and/or different bits (e.g., CA2-CA13) may be used to define the ACT command and the ACTPD command.

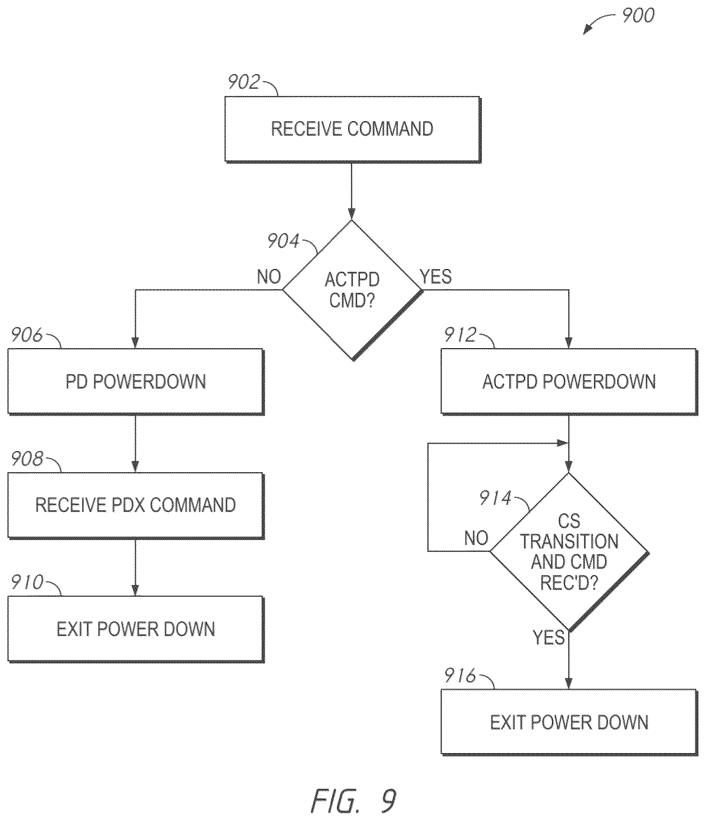

FIG. 9 illustrates a flowchart of an example method 900 of operating a memory device according to an embodiment of the disclosure. The memory device includes one or more memory ranks. The method is described as powering down one memory rank but can be used to power down multiple memory ranks at a time.

Initially, a command that causes a memory rank to power down is received at block 902. In one example, a host device may transmit a command to a controller that will cause a memory module to be powered down. In response, the controller can transmit a PDE command or an ACTPD command to the memory module to cause the memory rank to power down. As described previously, the PDE command will cause the first set of circuits to power down and the ACTPD command will cause the second set of circuits to power down.

At block 904, a determination is made as to whether the ACTPD command was the command that was received at block 902. For example, the determination may be based on the state of the CA1 bit in the command. If a determination is made that the ACTPD command was not received at block 902, the method passes to block 906 where the PDE command is executed and the first set of circuits in the memory rank powers down. At block 908, a PDX command is received. At block 910, the first set of circuits in the inactive memory rank exits power down.

Returning to block 904, when a determination is made that the ACTPD command was received at block 902, the method continues at block 912 where the ACTPD command is executed and the second set of circuits in the memory rank powers down. At block 914, a determination is made as to whether the CS signal provided to the inactive memory rank is transitioning to an active signal level (e.g., a “0” or low) and a command is received on the CA bus. If not, the method waits at block 914. When a determination is made that the CS signal is transitioning to the active signal level and a command is received on the CA bus, the method proceeds to block 916 where the second set of circuits in the memory rank exit power down.

The foregoing description, for purposes of explanation, uses specific nomenclature to provide a thorough understanding of the described embodiments. However, it will be apparent to one skilled in the art that the specific details are not required to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A memory device, comprising:
a command decoder configured to provide a plurality of power down signals, the plurality of power down signals comprising a first powerdown signal in response to a first power down command and a second powerdown signal in response to a second power down command; and
a power down controller circuit configured to control a power down of a first set of circuits based on the first powerdown signal and to control a power down of a second set of circuits based on the second powerdown signal.

2. The memory device of claim 1, further comprising a command address input circuit configured to receive a plurality of commands and responsively provide internal command signals to the command decoder, the plurality of commands including a power down entry command and an activate with auto-powerdown command, wherein the power down entry command is associated with the first power down command and the activate with auto-powerdown command is associated with the second power down command.

3. The memory device of claim 1, wherein:
the first set of circuits comprises one or more circuits that use a first time period to exit power down;
the second set of circuits comprises one or more circuits that uses a second time period to exit power down; and
the second time period is less than the first time period.

4. The memory device of claim 3, wherein the one or more circuits that use the first time period to exit power down comprise command and address buffers and a voltage generator.

5. The memory device of claim 4, wherein:
the command and address buffers power down completely in response to the first powerdown signal; and
a voltage level output by the voltage generator is reduced in response to the first powerdown signal.

6. The memory device of claim 3, wherein the one or more circuits that use the second time period to exit power down comprise one or more circuits in a command/address input circuit.

7. The memory device of claim 3, wherein the one or more circuits that use the second time period to exit power down exit based on a combination of a transition in a control signal on a select signal line and a command on a command/address bus.

8. The memory device of claim 7, wherein:
the memory device is a first memory device in a plurality of memory devices;
the plurality of memory devices is connected to the command/address bus; and
the command on the command/address bus is to be executed by a second memory device in the plurality of memory devices.

9. The memory device of claim 3, wherein the one or more circuits that use the first time period to exit power down exit based on a received power down exit command.

10. The memory device of claim 1, wherein:
the power down controller circuit comprises a first logic circuit and a second logic circuit;
a first input of the first logic circuit is connected to a command/address input circuit;
a first input and a second input of the second logic circuit are connected to a command decoder circuit; and
an output of the second logic circuit is connected to a second input of the first logic circuit.

11. A method, comprising:
receiving, by a memory rank, a first command on a command/address bus;
powering down a set of circuits in the memory rank based on the first command;
detecting a transition in a chip select signal provided to the memory rank;
detecting a second command on the command/address bus; and
based on detection of the transition in the chip select signal and the second command on the command/address bus, exiting power down of the set of circuits.

12. The method of claim 11, wherein:
the set of circuits is a first set of circuits; and
the method further comprises:
receiving, by the memory rank, a third command on the command/address bus;
powering down a second set of circuits in the memory rank based on the third command;
receiving, by the memory rank, a power down exit command; and
responsive to the power down exit command, exiting power down of the second set of circuits.

13. A controller configured to transmit commands to a memory module, the commands comprising:
a power down entry command configured to power down a first set of circuits in a memory rank of the memory module; and
an activate with auto-powerdown command configured to power down a second set of circuits in the memory rank and cause the second set of circuits to exit power down.

14. The controller of claim 13, wherein the controller is configured to transmit a power down exit command configured to cause the first set of circuits to exit power down.

15. The controller of claim 13, wherein:
the first set of circuits comprises command address input buffers and a voltage generator circuit; and
the second set of circuits comprises one or more circuits in the command address input buffers.

16. A system, comprising:
a controller configured to transmit commands to a memory device, the commands comprising:
a power down entry command configured to power down a first set of circuits in a memory rank of the memory module; and
an activate with auto-powerdown command configured to power down a second set of circuits in the memory rank and cause the second set of circuits to exit power down; and
the memory device, comprising:
a command decoder configured to provide a first powerdown signal responsive to receipt of the power down entry command and a second powerdown signal responsive to receipt of the activate with auto-powerdown command; and
a controller circuit configured to receive the first powerdown signal and the second powerdown down signal and responsively control powering down a first set of circuits in the memory device based on the first powerdown signal and a second set of circuits in the memory device based on the second powerdown signal.

17. The system of claim 16, wherein:
the controller circuit comprises a first logic circuit and a second logic circuit;
a first input of the first logic circuit is connected to a command/address input circuit;
a first input of the second logic circuit is configured to receive the first powerdown signal;
a second input of the second logic circuit is configured to receive the second powerdown signal; and
output of the second logic circuit is connected to a second input of the first logic circuit.

18. The system of claim 17, further comprising a voltage generator connected to the first input of the second logic circuit.

19. The system of claim 16, wherein the controller is configured to provide a power down exit command after providing the power down entry command.

20. The system of claim 16, wherein:
the first set of circuits comprises one or more circuits that use a first time period to exit power down;
the second set of circuits comprises one or more circuits that use a second time period to exit power down; and
the second time period is less than the first time period.

21. The system of claim 20, wherein:
the first set of circuits comprises one or more command and address input buffers and a voltage generator;
the one or more command and address buffers power down completely; and
a voltage level output by the voltage generator is reduced.
